(19) United States
(12) Patent Application Publication
(10) Pub. No.: US 2016/0026608 A1
(43) Pub. Date: Jan. 28, 2016

(54) Method and Apparatus for Generating Multimodal Dialog Applications by Analyzing Annotated Examples of Human-System Conversations

(71) Applicant: NUANCE COMMUNICATIONS, INC., Burlington, MA (US)

(72) Inventors: Jan Curin, Prague 4 - Chodov (CZ); Jacques-Olivier Goussard, Greenfield Park (CA); Real Tremblay, Outremont (CA); Richard J. Beaufort, Corbais (BE); Jan Kleindienst, Prague 4 - Chodov (CZ); Jiri Havelka, Prague 4 - Chodov (CZ); Raimo Bakis, Yorktown Heights, NY (US)

(73) Assignee: NUANCE COMMUNICATIONS, INC.

(21) Appl. No.: 14/337,551

(22) Filed: Jul. 22, 2014

(51) Int. Cl. G06F 17/21; G06F 17/24

(52) U.S. Cl. CPC G06F 17/211; G06F 17/241

(57) ABSTRACT

Designing a dialog application is a difficult task that typically requires a complete understanding of the dialog framework and a high level of expertise to map system requirements to the actual implementations. In contrast, determining the logic of the dialog application via sample interaction is typically very simple and efficient. A developer can describe via speech or text what the operations of the application are, effectively writing dialog samples. Methods described herein reverse the way dialog applications are designed by obtaining annotated dialog samples and defined concepts related to a requested dialog application; analyzing the annotated dialog samples, defined concepts, and one or more relationships between or among the defined concepts; and generating an executable dialog application based on the analysis of the annotated dialog samples and the defined concepts.

### COMMON OWNERSHIP UNDER JOINT RESEARCH AGREEMENT 35 U.S.C. 102(c)

The subject matter disclosed in this application was developed, and the claimed invention was made by, or on behalf of, one or more parties to a joint Research Agreement that was in effect on or before the effective filing date of the claimed invention. The parties to the Joint Research Agreement are as follows, Nuance Communications, Inc. and International Business Machines Corporation.

### BACKGROUND OF THE INVENTION

Achieved advances in speech processing and media technology have led to a wide use of automated user-machine interaction across different applications and services. Using an automated user-machine interaction approach, businesses may provide customer services and other services with relatively inexpensive cost.

### SUMMARY OF THE INVENTION

Embodiments of the present invention provide methods and apparatuses that support quickly creating dialog applications within a multimodal dialog framework. Such applications are developed by providing a library of methods for generating dialog system specifications in an automatic or semiautomatic manner. These dialog applications are developed based on examples of human-system conversation, human-human conversation, ontological descriptions of the application domain, and/or abstract backend capabilities. Abstract backend capability may include a description of the underlying data model and its operations. The multimodal dialog system specification is composed of, for example, a dialog flow description in the form of logical, (AND/OR/XOR), and temporal, (SEQ—sequential), operators on acquired data and mandatory and one or more descriptions of optional information to be collected by the dialog application. The multimodal dialog system specification may be further composed of dialog strategies, i.e., confirmation and disambiguation of data, and the structure and form of system prompts. Further, the dialog specification may be generated from a reasonable amount of human-system conversation examples annotated with semantic meaning using a combination of heuristic and statistical methods.

According to at least one example embodiment, a method of automatically generating a dialog application comprises: obtaining, by a computer system, annotated dialog samples and defined concepts related to a requested dialog application; analyzing the annotated dialog samples, defined concepts, and one or more relationships between or among the defined concepts; and generating an executable dialog application based on the analysis of the annotated dialog samples and the defined concepts.

An embodiment further comprises validating the generated executable dialog application based on the obtained annotated dialog samples or any other set of annotated or unannotated dialog samples. Another example embodiment further comprises presenting, via a user interface, an annotated dialog sample as an indication of the association between at least one concept and an utterance in the annotated dialog sample.

According to an embodiment of the present invention, analyzing the annotated dialog samples includes determining roles of single utterances or dialog segments within a corresponding dialog sample of the annotated dialog samples. Yet further still, analyzing the annotated dialog samples according to an embodiment of a method of the present invention includes determining at least one of: information for acquisition by the executable dialog application, information that is mandatory during acquisition by the executable dialog application, information that is optional during acquisition by the executable dialog application, information that is correctable during acquisition by the executable dialog application, information associated with information disambiguation during acquisition by the executable dialog application, and information to be confirmed by the executable dialog application.

In yet another embodiment of the present invention, analyzing the annotated dialog samples includes determining an order of dialog elements, wherein the order of dialog elements is used in generating the executable dialog application. Yet further still, analyzing the annotated dialog samples may include determining a generic form of a system prompt for execution by the dialog application according to an example embodiment.

In an embodiment, generating the executable dialog application comprises generating output templates indicative of system prompts for execution by the executable dialog application. Further, in another embodiment, generating the executable dialog application includes providing a user interface for managing the application. According to such an embodiment, the user interface allows tuning of at least one module of the executable dialog application.

Another embodiment of the present invention is directed to an apparatus for automatically generating a dialog application. In such an embodiment, the apparatus comprises a processor and memory with computer code instructions stored thereon, wherein the processor and the memory, with the computer code instructions, are configured to cause the apparatus to obtain: annotated dialog samples and defined concepts related to a requested dialog application; analyze the annotated dialog samples, defined concepts, and one or more relationships between or among the defined concepts; and generate an executable dialog application based on the analysis of the annotated dialog samples and the defined concepts.

According to an embodiment of the apparatus, the processor and the memory with the computer code instructions are further configured to cause the apparatus to validate the generated executable dialog application based upon the obtained annotated dialog samples, and/or any other set of annotated or un-annotated dialog samples. In yet another embodiment of the apparatus, the computer code instructions are further configured to cause the apparatus to provide a user interface to display an annotated dialog sample as an indication of an association between at least one concept and an utterance in the annotated dialog sample.

In another example apparatus embodiment of the present invention, the processor and the memory with the computer code instructions are further configured to cause the apparatus to analyze the annotated dialog samples to determine roles of single utterances or dialog segments within a corresponding dialog sample of the annotated dialog samples. In an alternative embodiment of the apparatus, analyzing the annotated dialog samples may comprise determining at least one of: information for acquisition by the executable dialog application, information that is mandatory during acquisition by the executable dialog application, information that is optional during acquisition by the executable dialog application, information that is correctable during acquisition by the executable dialog application, information associated with information disambiguation during acquisition by the executable dialog application, and information to be confirmed by the executable dialog application.

According to yet another embodiment of the apparatus, the processor and the memory with the computer code instructions may be further configured to cause the apparatus to determine an order of dialog elements, wherein the order of dialog elements is used to generate the executable dialog application. Yet further still, in an example embodiment of the apparatus, analyzing the annotated dialog samples further comprises configuring the apparatus to determine a generic form of a system prompt for execution by the executable dialog application. Another embodiment of the apparatus is configured by the processor and the memory with the computer code instructions to determine output templates indicative of system prompts. In an alternative embodiment of the apparatus, in generating the executable dialog application, the processor and the memory with the computer code instructions are further configured to cause the apparatus to provide a user interface for managing the executable dialog application.

Yet another embodiment of the present invention is directed to a cloud computing implementation for generating an executable dialog application. Such an embodiment is directed to a computer program product executed by a server in communication across a network with one or more clients. In such an embodiment, the computer program product comprises a computer readable medium which comprises program instructions which, when executed by a processor causes: obtaining annotated dialog samples and defined concepts related to a requested dialog application; analyzing the annotated dialog samples, defined concepts, and one or more relationships between or among the defined concepts; and generating an executable dialog application based on the analysis of the annotated dialog samples and the defined concepts.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a visual depiction of a system for generating a dialog application according to an embodiment of the present invention.

FIG. 2 is a flowchart depicting a method of generating a dialog application according to at least one example embodiment.

FIG. 3 is a simplified block diagram of a system for automatically generating a dialog application according to an embodiment of the present invention.

FIG. 4 is a visual depiction of an ontology which may be utilized in one or more embodiments of the present invention.

FIG. 5 depicts annotated dialog that may be used in an example embodiment of the present invention.

FIG. 6 is a depiction of dialog and respective acts associated with dialog segments determined by executing an embodiment of the present invention.

FIG. 7 is a matrix depicting the theoretical signatures for “AND”, “OR”, “XOR”, and “SEQ” operators that may be utilized by embodiments of the present invention.

FIG. 8 depicts a logical task structure that may be developed according to at least one example embodiment.

FIG. 9 depicts example generic forms of system prompts that may be determined when generating a dialog application according to one or more embodiments of the present invention.

FIG. 10 depicts the result of a dialog application validation process that may be performed in an example embodiment.

FIG. 11 is a simplified diagram of a computer network environment in which an embodiment of the present invention may be implemented.

### DETAILED DESCRIPTION OF THE INVENTION

A description of example embodiments of the invention follows.

Designing a dialog application is a challenging task even when using the most modern declarative dialog frameworks, such as voice extensible markup language (VXML) or graphical tools built upon it. Describing a successful application structure from user requirements typically requires a deep and complete understanding of the dialog framework intricacies and a high level of expertise to map system requirements to the actual implementation. On the other hand, describing the global dialog logic via sample interactions is a very simple and efficient task. Without any knowledge of the dialog framework, a developer is able to describe via speech or text, for example, what the operations of the application are, effectively writing dialog samples. Such samples are usually used to validate a posteriori the developed application.

Embodiments of the present invention overcome such difficulties in developing dialog applications. One or more embodiments of the present invention reverse the way applications are designed. Embodiments leverage the sample dialogs as the application description. Starting from annotated examples of human-system communication, e.g., speech, text, gestures, and a graphical user interface, and a formal description of the concepts manipulated by the application (an ontology), embodiments of the invention described herein aim at a complete derivation of the dialog system that covers the entered dialog examples and requires minimal manual intervention by the user. Once the global dialog structure is covered, the developer is left to the task of adding the domain-specific application logic, e.g., the problem-solving logic.

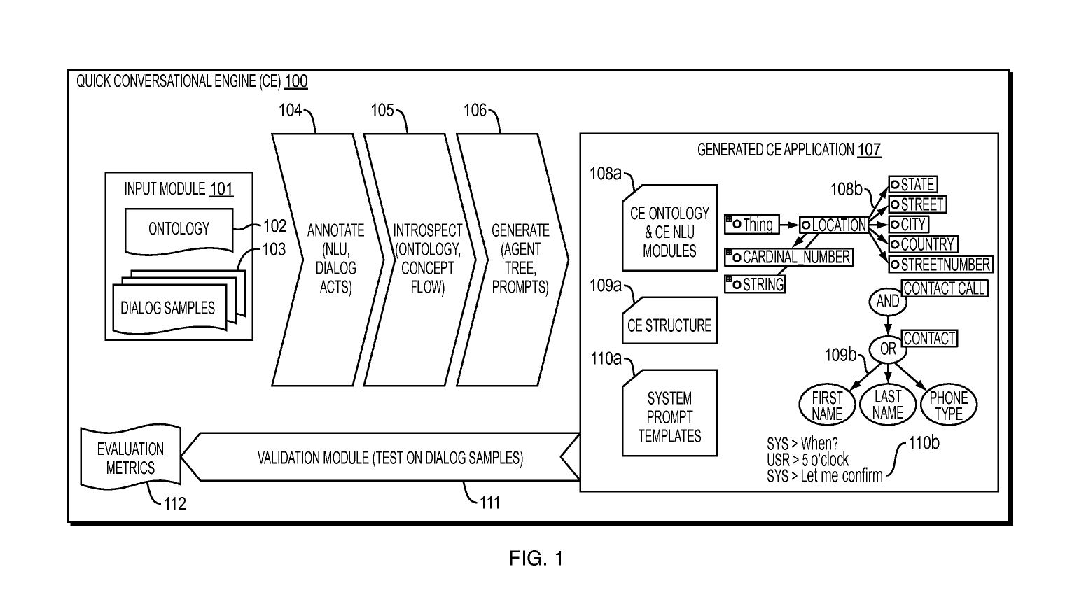

FIG. 1 illustrates a simplified diagram of a system 100 for generating a dialog application 107 according to an embodiment of the present invention. The terms dialog application and conversational engine may be used interchangeably herein. The system 100 comprises the input module 101 for receiving and/or generating data to be processed by the annotation module 104, the introspection module 105, and the generation module 106. With the data from input module 101, the annotation module 104, the introspection module 105, and the generation module 106 function together to develop the conversational engine 107. The conversational engine 107 may be composed of three major constituent parts: the ontology/grammar module 108a, the structure module 109a, and the system prompt templates 110a. The system 100 further comprises a validation module 111 that tests the conversational engine 107 and yields the evaluation metrics 112.

The system 100 comprises an input module 101, which receives and/or generates one or more ontologies 102 and dialog samples 103. The ontologies 102 and dialog samples 103 received at the input module 101 may be in a final form needed by the system 100 or may be further processed, for example, by the annotation module 104. The input module 101 is capable of receiving conversation in many forms, such as speech and text, the received conversations may, in turn, be further processed to generate an ontology and/or annotated dialog based on the received conversations. An ontology may be considered a formal description of the concepts manipulated by the application. Similarly, an ontology may be a formal representation of a set of concepts within a domain and a relationship between or among those concepts.

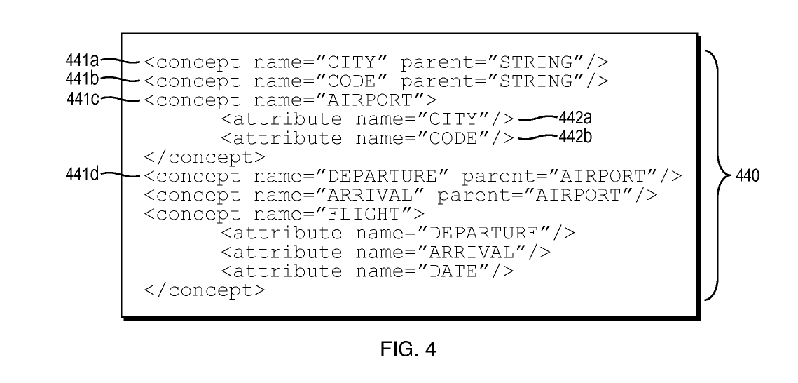

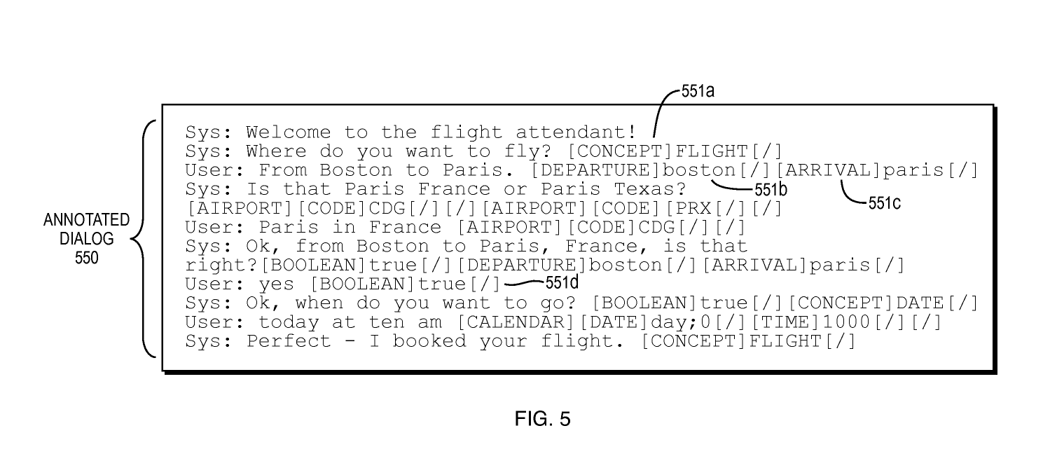

In embodiments of the present invention, the ontology 102 is related to the domain of the dialog application to be generated, e.g., flight booking, and the relationship between the concepts of the application. An example of an ontology is depicted in FIG. 4 and described hereinbelow. Further, the inputs 101 comprise the dialog samples 103. The dialog samples 103 may be as described herein in relation to FIG. 5.

The input module 101 may be capable of loading, either manually, automatically, or semi-automatically, the ontology 102 and/or dialog samples 103. The input module 101 may load the ontology 102 and dialog samples 103 from any point communicatively coupled to the input module 101 and/or the system 101. In an example embodiment, wherein the system 100 is executed by a computing device, the input module 101 may load the ontology 102 and dialog sample 103 via any communication means known in the art, for example, using a wide area network (WAN) or local area network (LAN). Further, in an embodiment executed by a computing system, the ontology 102 and dialog samples 103 may be loaded from a local disk, database, server, or any combination thereof, located locally or remotely in relation to the system 100 and communicatively coupled thereto.

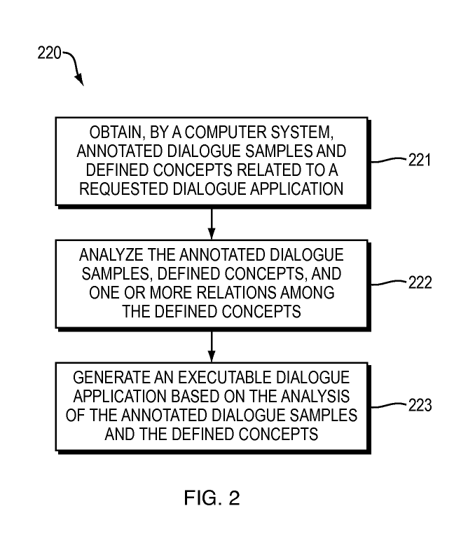

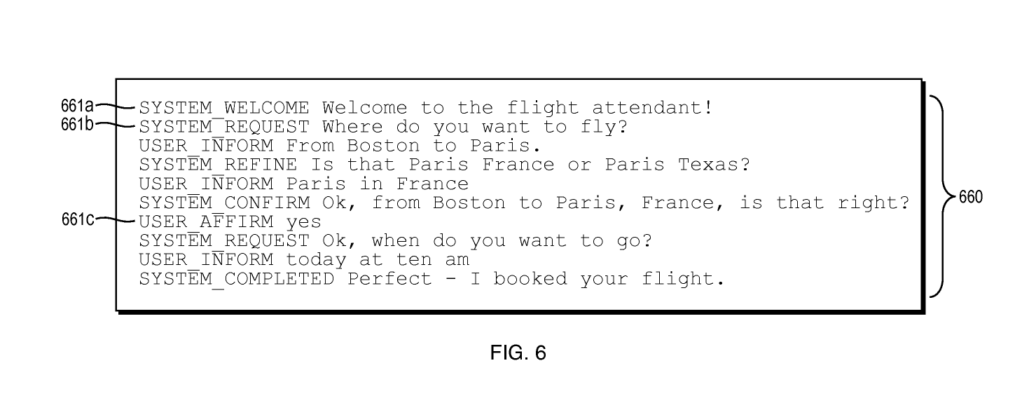

The ontology 102 and dialog samples 103, i.e., conversation that includes a sequence of utterances (that are either user or system interactions) are next used by the annotation module 104. The annotation module 104 infers, automatically or semi-automatically, the global meaning of each sample dialog 103 using a combination of heuristic and statistical techniques. Further, the annotation module 104 may provide users with an interface to annotate dialogs as shown in FIG. 4. The annotation module 104 may infer, automatically or semi-automatically, dialog acts as shown in FIG. 6. In such an example, inferred dialog acts, together with annotated concepts, may form a meaning for each element (or interaction) of the sample dialog. The term dialog act may be a used in relation to FIG. 6 described hereinbelow. Any suitable techniques known in the art may be used, as long as the determined inferred meanings are in a form suitable for use by the various other modules of the system 100. The annotation module 104 may represent a tool to annotate conversation with ontological concepts, accepting conversations in many forms, which may be received from the input module 101. Further function of the annotation module 104 may be as described herein below in relation to FIG. 2.

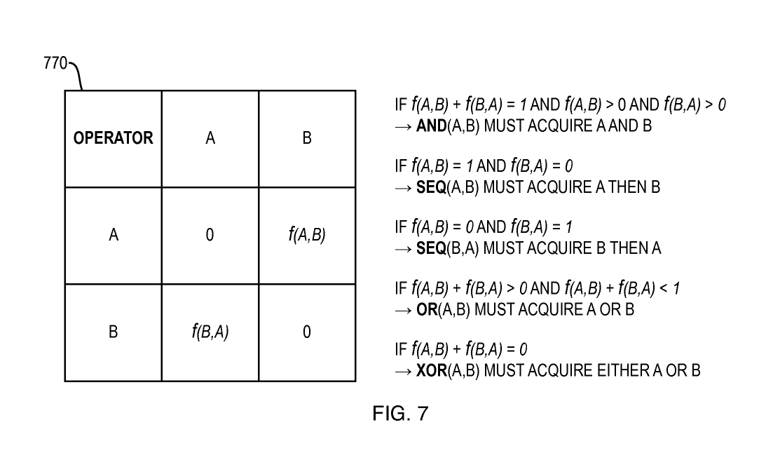

The introspection module 105 next performs various tasks including inferring various pieces of information based on the other modules'information, such as the annotation module's 104 information. For example, if the annotation module 104 determines that the system answered a question, the introspection module 105 may determine that a given concept relating to that question is mandatory based on the fact that the system answered the question about the concept. The introspection module 105 may further comprise a task structure detector module (not shown) that infers, from the other modules' information, the temporal and logical order of acquisition of the different concepts mentioned in the dialog samples 103. Additionally, the introspection module 105 may further develop and infer the generic form of system prompts that may be used in the dialog application 107. The various functions of the introspection module 105 may be those described herein below in relation to operation 222 of the method 220, FIG. 2, and FIGS. 7-9.

The generation module 106 is used to generate the conversational engine 107 using the results of the annotation module 104 and the introspection module 105. The dialog specification generator module 106 may generate the application specification in a form suitable for an existing task-based dialog manager. This generator module 106 may generate, for example, an application specification in the form of a set of VXML forms. Alternatively, the generator module 106 may automatically generate code for more advanced task-based dialog systems, as long as such systems have some support for the binary operators described herein, i.e., the “AND”, “OR”, “XOR”, and “SEQ” operators. For example, the generation module 106 may generate specifications for a dialogue manager using principles known in the art. For example, the generation module 106 may generate specification for RavenClaw™ using the RavenClaw™ task specification language or generate specifications in VXML. The generation module 106 may generate the output templates in any form suitable for existing prompt engines, for example, it may generate Speech Synthesis Markup Language (SSML) prompts for a text to speech system or HyperText Markup Language (HTML) forms for a web interface.

The result of the generation module 106 is the conversational engine 107. One may consider the conversational engine 107 to be composed of three modules: an ontology/grammar module 108a, a structure module 109a, and a system prompt template module 110a. The ontology/grammar module 108a comprises an ontology, such as the ontology 108b, specific to the application of the conversational engine 107. The ontology/grammar module 108a further comprises grammar rules that dictate functions of the conversational engine 107. The conversation engine 107 further includes a conversational structure module 109a that governs the conceptual flow of the conversational engine's 107 function. The conversational structure may be given, for example, by VXML pages or RavenClaw™ agents. The agent structure 109b depicts a conversational structure that may be determined by the conversational structure module 109a for a given application. System prompt templates 110a are further included in the conversational engine 107. System prompt templates are actual templates of conversations that may be used by the conversation engine 107. For example, system prompts may include “when” and “let me confirm” as shown by the sample conversational templates 110b.

As described hereinabove, the system 100 further comprises a validation module 111 that is used to validate the conversational engine 107. The validation module 111 may use the dialog samples 103 and/or any other annotated or unannotated dialog samples to test the application 107. The validation module 111 may compute evaluation metrics 112 that may be used to assess the dialog application's coverage of the one or more dialogs used for validation. For example, the validation module 111 may compare the number of prompts generated to the expected number of successful and failed user input turns to determine the global success of the generated application 107. The metrics 112 may, in turn, be used to further refine the logic of the other modules, through user evaluation and/or manipulation or by providing feedback to the modules 101-106.

FIG. 2 is a flow diagram of a method 220 for generating a dialog application according to an embodiment of the present invention. The method 220 begins by obtaining annotated dialog samples and defined concepts related to a requested dialog application (221). The dialog samples may be annotated in any way as is known in the art. For example, the dialog samples may be annotated as shown in FIG. 5. The defined concepts may refer to an ontology. An ontology is a formal description of concepts, i.e., a formal representation of a set of concepts within a domain and the relationship between or among those concepts. An example ontology that may be obtained at block 221 of the method 220 is shown in FIG. 4 and described hereinbelow. The annotated dialog samples and defined concepts may be obtained through any means known in the art. For example, if the method 220 is being performed by a computing system, the defined concepts may be obtained from a local disk, a remote storage device, and/or a database. Further, in such an example embodiment, the defined concepts and annotated dialog samples may be obtained in response to a user command or may be obtained automatically, semi-automatically, or on some periodic basis. Further still, the data may be obtained from any point or combination of points communicatively coupled, via any means known in the art, to a computing device executing the method 220.

After obtaining the dialog samples and defined concepts (221), the method 220 next analyzes the annotated dialog samples, defined concepts, and one or more relationships between or among the defined concepts (222). Analyzing the dialog samples and defined concepts may comprise a multitude of tasks depending upon the embodiment of the method 220. According to an embodiment of the method 220, analyzing the annotated dialog samples (222) includes determining roles of single utterances or dialog segments within a corresponding dialog sample. For example, determining the role of an utterance may comprise a determination that the utterance “yes” from a user is an affirmation or a system dialog segment, “Where do you want to fly?” is a system request. Further still, determining the role of single utterances or dialog segments may be as described herein below in relation to FIG. 6.

According to an embodiment of the method 220, analyzing the annotated dialog samples, defined concepts, and relationships between or among the defined concepts (222) comprises determining at least one of: information for acquisition by the executable dialog application, information that is mandatory during acquisition by the dialog application, information that is optional during acquisition by the executable dialog application, information that is correctable during acquisition by the dialog application, information associated with information disambiguation during acquisition by the executable dialog application, and information to be confirmed by the executable dialog application. Such analysis may be considered dialog act introspection, and may comprise inferring various pieces of information based on information from the various analysis techniques performed by the method 220. For example, an analysis technique performed at block 222 may infer that a given concept is mandatory based on the fact that the system asks a question about it. In this example, if it is first determined that a system dialog segment was a SYSTEM REQUEST, it may then be inferred that such a concept is mandatory. In yet another example, it may be inferred that groups of concepts should be confirmed together. For example, if a dialog segment was determined to be a SYSTEM CONFIRM; such a determination may be used to form the structure of the dialog application. For example, groups of concepts which are confirmed together in the airlines domain can be: departure location and arrival location; departure location, arrival location, and date; and class, seat position, and meal restrictions. The analysis at block 222 may infer that such concepts should be confirmed together and the resulting dialog application will be structured accordingly.

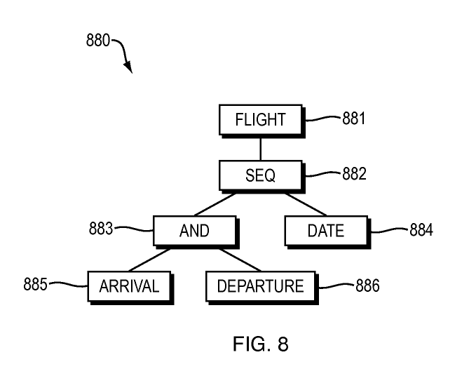

In an embodiment of the method (220), analyzing the annotated dialog samples (222) may comprise determining an order of dialog elements. The order of dialog elements may refer to the temporal and/or logical order of the different concepts mentioned in the sample dialogs obtained at operation 222. For example, in the domain of flight reservations, one may need to first determine the desired date of travel prior to determining what time on that date the user would like to fly. Further, determining the order of concepts performed in operation 222 of the method 220 may be performed as described hereinbelow in relation to FIGS. 7 and 8. In an embodiment of the present invention, the order of the dialog elements may be used when generating the executable dialog application (223).

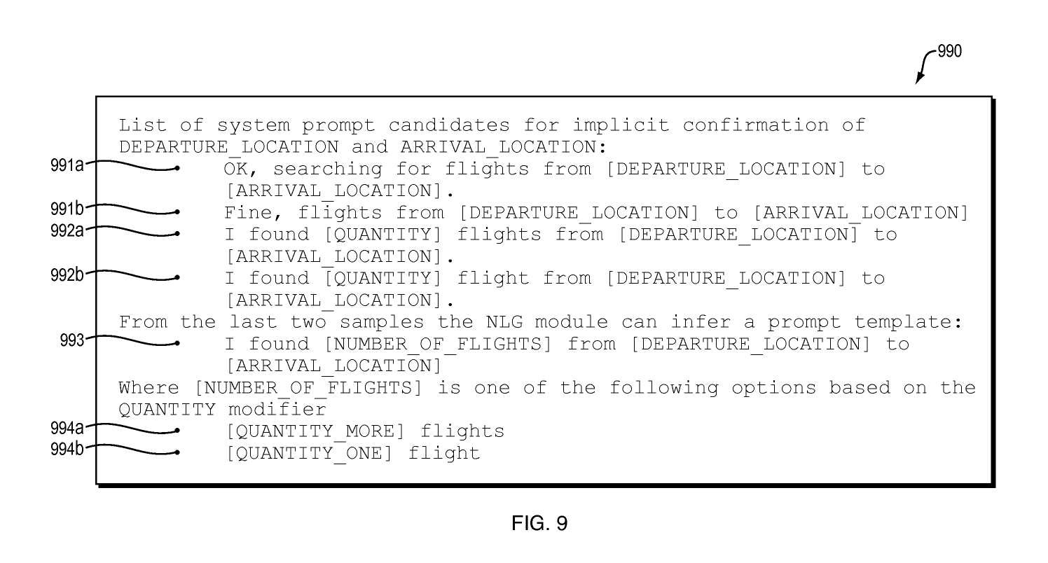

Yet further still, analyzing the annotated dialog samples and defined concepts (222) may comprise determining generic forms of system prompts for execution by the executable dialog application. In such an embodiment, generating the executable dialog application may include generating output templates indicative of the determined system prompts. For example, it may be inferred that a particular system prompt sample containing a given city name is a prompt to confirm a city. In such an example, the dialog “You want to fly from Boston, right?” would be transformed into the dialog template “You want to fly from [CITY], right?” Further, detail regarding determining system prompts may be as described hereinbelow in relation to FIG. 9.

After analyzing the dialog samples, defined concepts, and relations among the defined concepts (222), the final step of the method 220 is to generate an executable dialog application based on the analysis of the annotated dialog samples and the defined concepts (223). According to an embodiment of the method 220, generating the executable dialog application includes generating output templates indicative of system prompts. These templates may be in a generic form and used when generating the dialog application. In yet another embodiment of the method 220, generating the executable dialog application comprises providing a user interface for managing the executable dialog application.

The user interface provided in such an embodiment may be a Graphical User Interface (GUI) that may be displayed via a display device or any device known in the art. According to such an embodiment, the user interface may allow tuning of at least one module of the executable dialog application. In such an embodiment, the user may tune the modules via the GUI or any other interface known in the art. For example, the GUI may present the user with a way to load, modify, and create ontologies and load, modify, create, and annotate dialog samples. The GUI may also allow the user to correct and confirm the annotations determined through dialog act annotation and dialog act introspection as described herein.

Further still, the GUI may present the user with ways to correct, confirm, modify, and expand the dialog structure, inferred by a task structure detector analysis, and the dialog system output, i.e., the generic form of system prompts. In addition, the GUI may present the user with a way to save, load, and update generated dialog specifications, and run dialog validations and display the dialog outcome in a suitable graphical report format. As referred to herein, modules may refer to any processes performed in the method 220. In an embodiment of the method 220 that is executed by a computing device, the “modules” may refer to portions of computer code instructions used for executing the method 220. In such an embodiment, a user may tune the modules by altering the computer code instructions directly or through use of a GUI. Several analysis techniques are described herein, any combination of these techniques may be performed in an embodiment of the invention.

The executable dialog application may be generated (223) from the information that is determined in analyzing the dialog samples and defined concepts (222) as described herein as well from the dialog samples and defined concepts obtained (221). Generating the dialog application (223) may comprise generating an application specification in a form suitable for an existing task-based dialog manager, such as a VXML platform, e.g., Voxeo®, TellMe®, etc., and/or the RavenClaw™ engine. The application specification may be in the form of a set of VXML forms or automatically generated code for more advanced task-based dialog systems, as long as such systems have some support for the AND/OR/XOR/SEQ binary operators described herein. Further, the output templates that are generated may be in any form suitable for existing prompt engines, such as the Microsoft Speech Server Prompt Engine™, Nuance Vocalizer™, or LumenVox® Text-to-Speech, amongst others.

An alternative embodiment of the method 220 further comprises validating the generated executable dialog application. In such an embodiment, the executable dialog application may be validated using the annotated dialog samples obtained at block 221, or any other set of annotated or unannotated dialog samples. According to an embodiment of the method 220, the method 220 further comprises presenting, via an user interface, an annotated dialog sample as an indication of an association between at least one concept and an utterance in the annotated dialog sample.

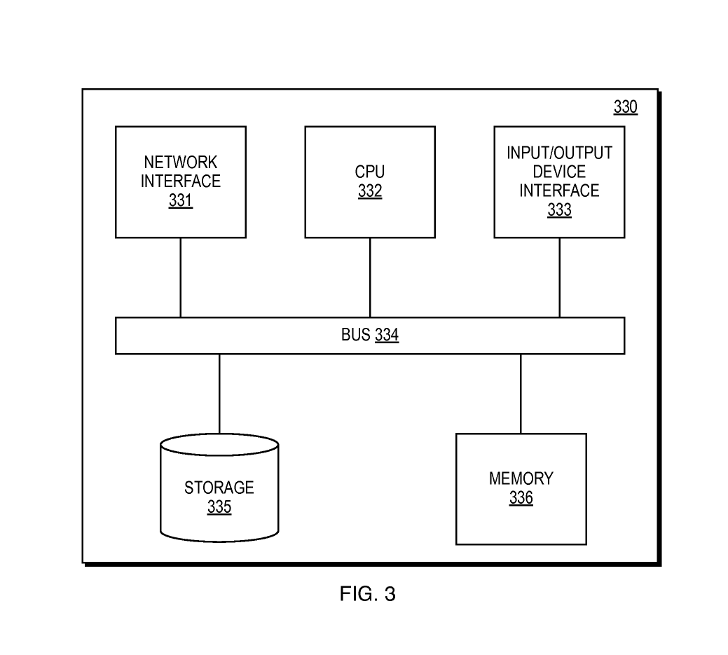

FIG. 3 is a simplified block diagram of a computer-based system 330, which may be used to generate a dialog application automatically according to the principles of the present invention. The system 330 comprises a bus 334. The bus 334 serves as an interconnect between the various components of the system 330. Connected to the bus 334 is an input/output device interface 333 for connecting various input and output devices, such as a keyboard, mouse, display, speakers, etc. to the system 330. A central processing unit (CPU) 332 is connected to the bus 334 and provides for execution of computer instructions. Memory 336 provides volatile storage for data used for carrying out computer instructions. Storage 335 provides non-volatile storage for software instructions such as an operating system (not shown). The system 330 also comprises a network interface 331 for connecting to any variety of networks known in the art, including wide area networks (WANs) and local area networks (LANs).

It should be understood that the example embodiments described herein may be implemented in many different ways. In some instances, the various methods and machines described herein may each be implemented by a physical, virtual, or hybrid general purpose computer, such as the computer system 330. The computer system 330 may be transformed into the machines that execute the methods described herein, for example, by loading software instructions into either memory 336 or non-volatile storage 335 for execution by the CPU 332.

The system 330 and its various modules may be configured to carry out any embodiments of the present invention described herein. For example, according to an embodiment of the invention, the system 330 obtains annotated dialog samples and defined concepts related to a requested dialog application. The system 330 may obtain this data via the network interface 331, the input/output device interface 333, and/or the storage device 335, or some combination thereof. Further, the system 330 analyzes the annotated dialog samples, defined concepts, and one or more relations among the defined concepts through execution by the CPU 332 of computer code instructions in the memory 336 and/or storage 335. Further, the dialog application is generated by the CPU 332 executing computer code instructions based on the analysis of the annotated dialog samples and defined concepts.

According to another embodiment, the system 330 may comprise various modules implemented in hardware, software, or some combination thereof. The modules may be as described herein. In an embodiment where the modules are implemented in software, the software modules may be executed by a processor, such as the CPU 332.

FIG. 4 is an example of an ontology 440 that may be obtained at block 221 of the method 220 or by the system 330. As described herein, an ontology is a set of defined concepts; as such, the ontology 440 comprises concepts such as the concepts 441a-d. The concepts 441a-d of the ontology 440 relate to the field of the dialog application that is being generated. For example, if the application relates to airline booking, as shown in FIG. 4, the ontology contains concepts related thereto, such as “CITY” 441a, “CODE” 441b, “AIRPORT” 441c, and “DEPARTURE” 441d. The ontology 440 may be loaded into a system executing an embodiment in accordance with the principles of the present invention, such as the system 330 via an ontology module. In such an embodiment, the ontology module may load the ontology from a database definition or other specifications. The ontology 440 illustrates an ontology defined in an XML format; however, an ontology used by embodiments of the invention may be defined in any form known in the art, such as the Web Ontology Language (OWL) format or CYC format, amongst others.

An ontology may also define relationships between concepts. The ontology 440 comprises the concepts “CITY” 441a, “CODE” 441b, and “AIRPORT” 441c. The ontology 440 further illustrates the relationship between the concepts 441a, 441b, and 441c, by illustrating that the “CITY” concept 441a and “CODE” concept 441b are attributes 442a and 442b of the “AIRPORT” concept 441c.

FIG. 5 is an example of an annotated dialog 550. The annotated dialog 550 has various annotations, such as the annotations 551a-d. Dialog annotations may be more general in nature, such as the concept annotation 551a, that indicates that the concept of the dialog is flights. Further, the annotation may be more specific and indicate such things as the departure annotation 551b and arrival annotation 551c. The annotations may also indicate a data type of an element of the dialog. For example, the annotation 551d indicates that the “yes” statement is a Boolean type that is true. The specific example in FIG. 5 relates to flights; however, embodiments of the present invention are not so limited and may generate dialog applications related to any subject matter. In such examples, the annotated dialogs and defined concepts are tailored accordingly.

As described herein, embodiments of the present invention analyze the annotated dialog samples, defined concepts, and one or more relations among the defined concepts; FIG. 6 illustrates the result of one such analysis technique, specifically dialog act annotation. Such a task may be performed at operation 222 of the method 220 and may be performed by a module, e.g., a dialog act annotator module, of the system 330. Inferred dialog acts together with annotated concepts may form a meaning of each user or system interaction. For example, a user interaction may be tagged as a “USER_INFORM” or “USER_AFFIRM” act, depending on whether it is merely answering a question from the system or confirming a piece of information. Similarly, a system interaction may be tagged as a “SYSTEM_CONFIRM” or “SYSTEM_REQUEST” act, depending on whether the interaction is asking for confirmation of data or requesting a new piece of information. FIG. 6 illustrates various dialog act annotations for the sample dialog 660. For example, the statement “Welcome to the flight attendant!” is annotated 661a as a “SYSTEM_WELCOME,” and the statement “Where do you want to fly?” is annotated 661b as a “SYSTEM_REQUEST.” Similarly, the user's response “YES” to the “SYSTEM_CONFIRM” “Ok, from Boston to Paris, France, is that right?” is annotated as a “USER_AFFIRM” act 661c. In this manner, embodiments of the present invention annotate the acts of elements of the sample dialogs.

Other analyses of embodiments of the present invention may utilize dialog act annotations. For example, a dialog act introspection module may infer various pieces of information based on the dialog act annotation. A dialog act introspection module may infer that a given concept is mandatory based on the fact that the system asks a question about it (“SYSTEM_REQUEST” dialog act annotation). Further, the dialog introspection analysis may also determine groups of concepts that are confirmed together in one system prompt (“SYSTEM_CONFIRM” dialog act) to help to form the structure of the application. For example, concepts which are confirmed together in the airline domain can be departure location, arrival location, and date. While specific examples of dialog act introspection are described herein, embodiments of the present invention are not so limited and any variety of information may be inferred, such as information for acquisition by the dialog application, information that must be acquired by the application, information that is optional to acquire during execution of the application, information that is correctable, information that is associated with information disambiguation, and information that needs to be confirmed by the executable dialog application.

Another analysis technique that may be performed by an example embodiment of the present invention is task structure detection. This analysis may be performed by a module of the system 330, such as a task structure detector module, that may be a component of computer code instructions stored in the non-volatile storage 335 and/or memory 336 and executed by the CPU 332. Similarly, this analysis may be performed at operation 222 of the method 220. According to an embodiment of the present invention, a task structure detector module is used to infer, from the other modules information, the temporal order of acquisition and/or logical conditions on the acquisition of different concepts mentioned in the dialogs. Such an analysis may use basic binary operations such as “AND,” “OR,” “XOR,” (exclusive OR) and “SEQ” (sequential) that describe the scheme of acquisition of concepts. In such an example, the “AND(A,B)” binary operator requires that the system acquire both A and B, the “OR(A,B)” binary operator requires that the system acquire at least A or B, the “XOR(A,B)” binary operators requires that the system acquire exactly one of A and B, and the “SEQ(A,B)” operator requires the system to acquire A then B. To determine the above operators, the task structure detector analysis may compute frequencies of acquiring a concept, for example B, after another concept, for example A, has been acquired, and use a metric on these frequencies to determine the above operators. This metric gives rise to different patterns, i.e., signatures, for the operators that can be expressed in a two-by-two matrix 770 as shown in FIG. 7.

The symbols in the matrix 770 represent empirical frequencies given a set of sample dialogs, namely: f(A,B) is the count of dialogs in which both A and B were acquired, in the order first A, then B, divided by the count of dialogs where at least one of A and B were acquired. Analogously, f(B,A) is the count of dialogs in which both A and B were acquired, in the order first B, then A, divided by the count of dialogs where at least one of A and B were acquired. These frequencies can take values between 0 and 1, inclusive, and furthermore it holds that 0≦f(A,B)+f(B,A)≦1, on the assumption that any piece of information can be acquired at most once in a dialog. The four operators introduced above can be deduced from the following patterns (signatures) on the antidiagonal cells in the two-by-two matrix 770: XOR is implied when it holds that f(A,B)+f(B,A)=0; OR is implied when it holds that 0<f(A,B)+f(B,A)<1; AND is implied when it holds that f(A,B)+f(B,A)=1 and furthermore f(A,B)>0 and f(B,A)>0; and SEQ is implied when it holds either that f(A,B)=1 (and thus f(B,A)=0) or that f(B,A)=1 (and thus f(A,B)=0). These conditions can be described as follows: XOR is implied when there are no dialogs in which both A and B are acquired; OR is implied when there are dialogs in which both A and B are acquired, but there are also dialogs in which only one of A and B are acquired; AND is implied when both A nor B are always acquired together in a sample dialog and it is the case that both possible orders of acquiring A and B occur in the sample dialogs; SEQ is implied when both A and B are always acquired, but it is in only one of the two possible orders of acquiring the concepts A and B. The empirical frequencies f(A,B) and f(B,A) can be further utilized to, for example, determine the preferred order in which A and B should be collected with the AND operator.

The task structure detector module may compute these patterns on the loaded dialog samples and use the patterns (signatures) to infer the binary relations between concepts. The task structure analysis may also combine the binary operators into a more complex hierarchy using combinatory rules that match the temporal and/or logical execution of the sample dialogs. The module may also use the patterns (signatures) to detect dynamic parts of dialogs where data-driven logic must be injected by the user. For example, if half of the dialogs are showing that A and B must be acquired in sequence, and half of the dialogs are not showing that B must be acquired, the module may infer that there is some application logic that decides when B is necessary and when B is not.

FIG. 8 illustrates the task structure 880 that results from determining the logical task structure of the sample dialog illustrated in FIG. 5. The task structure 880 indicates that it relates to the flight concept 881. Further, the task structure 880 indicates that there is an AND relationship 883 between the arrival information 885 and the departure information 886, i.e., both arrival and departure information must be acquired. Further, the task structure 880 indicates a sequential order 882 between arrival 885 and departure information 886, and date information 884. Thus, the task structure 880 illustrates that first arrival 885 and departure 886 information must be determined and then the date 884.

Using the information described herein another analysis may be performed to infer the generic form of system prompts. This analysis may be performed by a module of the system 330 or by an embodiment of the method 220. Such an analysis may infer that a particular system prompt sample containing a given city name is actually a prompt to confirm a city. This may result in transforming “You want to fly from Boston, right?” into a template “You want to fly from [CITY], right?” FIG. 9 illustrates the system prompts 990 and their generic forms that may be determined from a sample dialog. Starting with the system prompt candidates 991a, 991b, 992a, and 992b, a prompt template can be inferred. From the samples 992a and 992b, a generic prompt template 993 is determined. FIG. 9 illustrates the generic prompt template 993 is customizable, i.e., the “NUMBER OF FLIGHTS” entry changes from “flights” to “flight” based on the quantity modifiers 994a and 994b.

The dialog specification may be generated using the information from the various analyses or a combination thereof, which may be performed by various modules. Further, the dialog application may be generated as described herein.

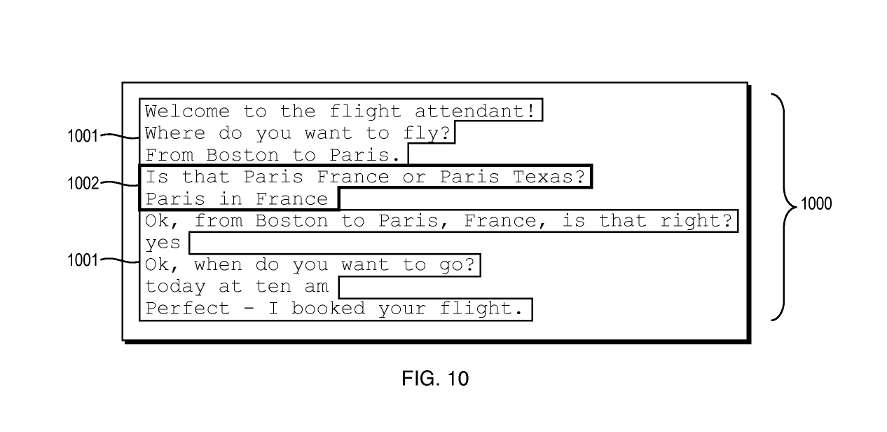

The dialog application may also be validated. The dialog application may be validated using a dialog validator module that automatically uses the provided user input samples to test the generated application and compute metrics to assess the sample coverage. The dialog validation analysis may compare the number of prompts generated to the number expected and/or the number of successful and failed user input turns to report the global success of the generated application. The result of the validation may be used to refine further the logic of any other analysis described herein. Output of the validation analysis may report uncovered parts of the dialog to a user, for example, using color coding as shown in FIG. 10. In FIG. 10, a dialog sample 1000 is shaded-coded (color-coded in color embodiments) with the different shades (colors) 1001 and 1002. FIG. 10 illustrates an example of a validation analysis indicating that the dialog application does not cover disambiguation. The validation analysis indicates that the dialog portions 1001 of the dialog sample 1000 are covered by the dialog application. However, FIG. 10 further illustrates that the dialog application does not cover disambiguation by way of highlighting the dialog portion 1002. The dialog portion 1002 provides disambiguation, i.e. it determines whether the user's request for a flight from Boston to Paris refers to Paris, France or Paris, Texas. In this example, the dialog application does not provide for such disambiguation, as illustrated by the highlighting 1002.

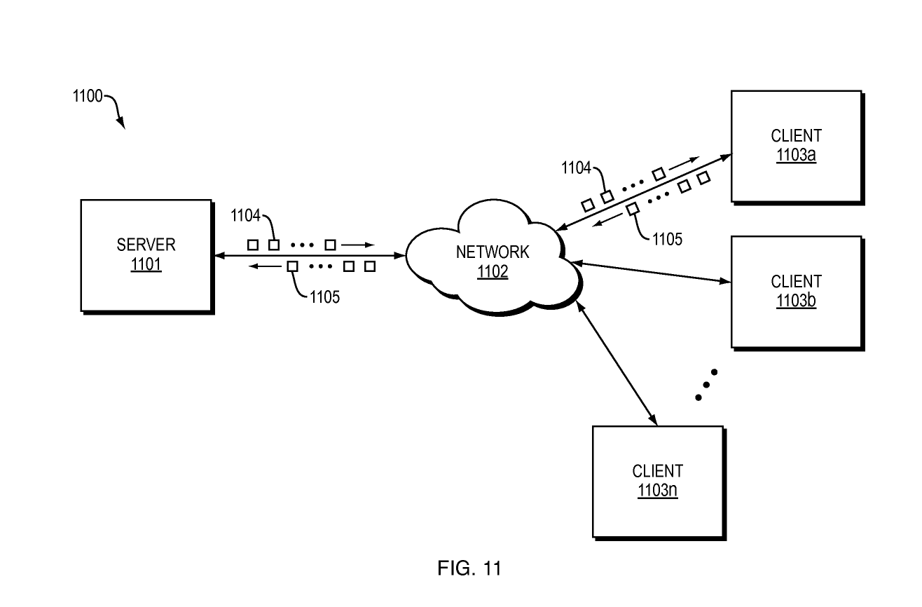

FIG. 11 illustrates a computer network environment 1100 in which the present invention may be implemented. In the computer network environment 1100, the server 1101 is linked through communications network 1102 to clients 1103a-n. The environment 1100 may be used to allow the clients 1103a-n alone or in combination with the server 1101 to execute the various methods described hereinabove. In an example embodiment, the client 1103a may send annotated dialog samples and ontologies, shown by the data packets 1105, via the network 1102 to the server 1101. In response the server 1101 will use the annotated dialog samples and ontologies 1105 to generate a dialog application which may then be transferred back to the client 1103a, shown by the data packets 1104, via the network 1102. In another embodiment, the dialog application is executed on the server 1101 and accessed by the clients 1103a-n via the network 1102.

It should be understood that the example embodiments described above may be implemented in many different ways. In some instances, the various methods and machines described herein may each be implemented by a physical, virtual, or hybrid general purpose computer, or a computer network environment such as the computer environment 1100.

Embodiments or aspects thereof may be implemented in the form of hardware, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should also be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

While this invention has been particularly shown and described with references to example embodiments thereof, it will be understood by those skilled in the art that various changes in form and details may be made therein without departing from the scope of the invention encompassed by the appended claims.

What is claimed is:

1. A method of automatically generating a dialog application comprising:
obtaining, by a computer system, annotated dialog samples and defined concepts related to a requested dialog application;
analyzing the annotated dialog samples, defined concepts, and one or more relationships between or among the defined concepts; and
generating an executable dialog application based on the analysis of the annotated dialog samples and the defined concepts.

2. The method as recited in claim 1 further comprising validating the generated executable dialog application based on the annotated dialog samples obtained or any other set of annotated or un-annotated dialog samples.

3. The method as recited in claim 1 further comprising:
presenting, via an user interface, an annotated dialog sample as an indication of an association between at least one concept and an utterance in the annotated dialog sample.

4. The method as recited in claim 1, wherein analyzing the annotated dialog samples includes determining roles of single utterances or dialog segments within a corresponding dialog sample of the annotated dialog samples.

5. The method as recited in claim 1, wherein analyzing the annotated dialog samples includes determining at least one of:
information for acquisition by the executable dialog application;
information that is mandatory during acquisition by the executable dialog application;
information that is optional during acquisition by the executable dialog application;
information that is correctable during acquisition by the executable dialog application;
information associated with information disambiguation during acquisition by the executable dialog application; and
information to be confirmed by the executable dialog application.

6. The method as recited in claim 1, wherein analyzing the annotated dialog samples includes determining an order of dialog elements, the order of dialog elements determined used in generating the executable dialog application.

7. The method as recited in claim 1, wherein analyzing the annotated dialog samples includes determining a generic form of a system prompt for execution by the executable dialog application.

8. The method as recited in claim 1, wherein generating the executable dialog application includes generating output templates indicative of system prompts for execution by the executable dialog application.

9. The method as recited in claim 1, wherein generating the executable dialog application includes providing a user interface for managing the executable dialog application.

10. The method as recited in claim 9, wherein the user interface allows tuning of at least one module of the executable dialog application.

11. An apparatus for automatically generating a dialog application comprising:
a processor; and
a memory with computer code instructions stored thereon, the processor and the memory, with the computer code instructions, being configured to cause the apparatus to:
obtain annotated dialog samples and defined concepts related to a requested dialog application;
analyze the annotated dialog samples, defined concepts, and one or more relationships between or among the defined concepts; and
generate an executable dialog application based on the analysis of the annotated dialog samples and the defined concepts.

12. The apparatus as recited in claim 11, wherein the processor and the memory, with the computer code instructions, are further configured to cause the apparatus to validate the generated executable dialog application based on the annotated dialog samples obtained or any other set of annotated or un-annotated dialog samples.

13. The apparatus as recited in claim 11, wherein the computer code instructions are further configured to cause the apparatus to provide a user interface to display an annotated dialog sample as an indication of an association between at least one concept and an utterance in the annotated dialog sample.

14. The apparatus as recited in claim 11, wherein in analyzing the annotated dialog samples, the processor and the memory, with the computer code instructions, are further configured to cause the apparatus to determine roles of single utterances or dialog segments within a corresponding dialog sample of the annotated dialog samples.

15. The apparatus as recited in claim 11, wherein in analyzing the annotated dialog samples, the processor and the memory, with the computer code instructions, are further configured to cause the apparatus to determine at least one of:
information for acquisition by the executable dialog application;
information that is mandatory during acquisition by the executable dialog application;
information that is optional during acquisition by the executable dialog application;
information that is correctable during acquisition by the executable dialog application;
information associated with information disambiguation during acquisition by the executable dialog application; and
information to be confirmed by the executable dialog application.

16. The apparatus as recited in claim 11, wherein in analyzing the annotated dialog samples, the processor and the memory, with the computer code instructions, are further configured to cause the apparatus to determine an order of dialog elements, the order of dialog elements determined used in generating the executable dialog application.

17. The apparatus as recited in claim 11, wherein in analyzing the annotated dialog samples, the processor and the memory, with the computer code instructions, are further configured to cause the apparatus to determine a generic form of a system prompt for execution by the executable dialog application.

18. The apparatus as recited in claim 11, wherein in generating the executable dialog application, the processor and the memory, with the computer code instructions, are further configured to cause the apparatus to determine output templates indicative of system prompts for execution by the executable dialog application.

19. The apparatus as recited in claim 11, wherein in generating the executable dialog application, the processor and the memory, with the computer code instructions, are further configured to cause the apparatus to provide a user interface for managing the executable dialog application.

20. A computer program product executed by a server in communication across a network with one or more clients, the computer program product comprising:
a computer readable medium, the computer readable medium comprising program instructions which, when executed by a processor causes:
obtaining annotated dialog samples and defined concepts related to a requested dialog application;
analyzing the annotated dialog samples, defined concepts, and one or more relationships between or among the defined concepts; and
generating an executable dialog application based on the analysis of the annotated dialog samples and the defined concepts.
